(19) United States
(12) Patent Application Publication
(10) Pub. No.: US 2016/0092811 A1
(43) Pub. Date: Mar. 31, 2016

(54) BUSINESS RULES FRAMEWORK

(71) Applicant: Bank of America Corporation, Charlotte, NC (US)

(72) Inventors: Shankar Iyer, E. Windsor, NJ (US); Daljeet Singh Maken, Plainsboro, NJ (US); Sundar Krishnamoorthy, E. Windsor Township, NJ (US); Suresh G. Nair, Robbinsville, NJ (US)

(21) Appl. No.: 14/502,325

(22) Filed: Sep. 30, 2014

(51) Int. Cl. G06Q 10/06; G06N 5/04

(52) U.S. Cl. CPC G06Q 10/0637; G06N 5/046

(57) ABSTRACT

A business rule framework may be used to provide a vendor agnostic interface to allow one or more business users to design, deploy, test and/or monitor an operation of one or more business rules using a common user interface. The business rule framework may allow a user access to a business rule management system (BRMS) using a common interface, regardless of a vendor or version of BRMS being used by a business organization. The business rule framework may include a business rule governance interface allowing the business user with the common user interface to the BRMS, regardless of the version or vendor of the BRMS product being used. The business rule framework may also include a BRMS interface capable of communicating with different BRMS products.

### BACKGROUND

A business organization, such as a financial institution, an insurance provider, a healthcare organization, a utility, and/or the like, an educational institution, or a governmental organization may define one or more rules for defining the structure of business operations across different business units. For example, these rules may be used to control the operation of the business organization by defining constraints under which the business organization, and its underlying business units, operate. In practice, the business rules may be used by the business organization to ensure consistent operation across the enterprise.

### SUMMARY

In light of the foregoing background, the following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

A business rule framework may be used to provide a vendor agnostic interface to allow one or more business users to design, deploy, test and/or monitor an operation of one or more business rules using a common user interface. The business rule framework may allow a user access to a business rule management system (BRMS) using a common interface, regardless of a vendor or version of BRMS being used by a business organization. The business rule framework may include a business rule governance interface allowing the business user with the common user interface to the BRMS, regardless of the version or vendor of the BRMS product being used. The business rule framework may also include a BRMS interface capable of communicating with different BRMS products.

In some embodiments, a system for implementing a business rule framework may include a business rule design interface tool comprising at least one user interface screen presented to a designer via a display device. The at least one user interface screen may allow a user to enter business rule information corresponding to an operation of a business rule using a common design format. The system may further include a business rule maintenance interface tool that may comprise at least one user interface screen presented to a user associated with a business unit. The user interface screen may allow the user to administer at least one of a plurality of business rules for use in one or more business processes, such as by testing an operation of the rule and/or monitoring the rule after deployment. The system may further include a business rule deployment manager that may be configured to communicate at least one instance of the plurality business rules retrieved from a business rules management system (BMRS) associated with the business rule framework. These rule instances may be communicated to a rule execution server for use in the one or more business processes associated with the business unit. In some cases, the business rules may be deployed in a common format and/or from a central data repository. Further, the system may include a business rule management system interface. This business rule management system may comprise a BRMS interface tool communicatively coupled to the business rule governance interface and configured to translate the business rule information received in the common design format into one or more different design formats, at least one of which being compatible with the BMRS.

In some embodiments, a computing device may be configured to provide by a design interface of a business rule framework, a first rule design interface screen having a vendor agnostic business rule design interface for entry of a plurality of business rules. The computing device may then determine, such as by a design translator of the business rule framework, whether a received first business rule is compatible with a first business rule management system (BRMS) underlying the business rule framework. The computing device may then communicate, such as by a design translator, an untranslated version of the first business rule to the BRMS when compatible with the BRMS, or a translated version of the received business rule when not compatible with the BRMS. The computing device may then be configured to deploy, such as by a deployment manager of the BRSM, when rule when requested via a maintenance interface of the business rule framework.

In some embodiments, an apparatus for providing a business rule framework may include a user interface having a display and configured to display one or more user interface screens associated with a designing a business rule. The apparatus may further include a business rule governance interface comprising at least one computing device, wherein the at least one computing device may include a business rule design interface tool, a business rule maintenance interface tool and/or a business rule deployment manager and/or a business rule management system. The business rule design interface tool may include at least one user interface screen presented to a designer via a display device, The at least one user interface screen may allow a user to enter business rule information corresponding to an operation of a business rule using a common design format. The business rule maintenance interface tool may include at least one user interface screen presented to a user associated with a business unit and allowing the user to administer at least one of a plurality of business rules for use in one or more business processes The business rule deployment manager may communicate one or more instances of the plurality business rules retrieved from a first business rules management system (BMRS) to a rule execution server for use in the one or more business processes associated with the business unit. In some cases, the business rules may be deployed using a common deployment format. The business rule management system interface may include a BRMS interface tool communicatively coupled to the business rule governance interface and configured to translate the business rule information received in the common design format into one or more different design formats, at least one of which being compatible with the first BMRS.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

A more complete understanding of aspects of the present disclosure and the advantages thereof may be acquired by referring to the following description in consideration of the accompanying drawings, in which like reference numbers indicate like features, and wherein:

FIG. 1 shows an illustrative operating environment in which various aspects of the invention may be implemented;

FIG. 2 is an illustrative block diagram of workstations and servers that may be used to implement the processes and functions of certain aspects of one or more aspects of the present disclosure;

FIG. 3 shows an illustrative block diagram of a system to provide a business rule framework according to one or more aspects of the present disclosure;

FIGS. 4 and 5 show illustrative block diagrams of systems in which a business rule framework may be used according to one or more aspects of the present disclosure; and

FIG. 6 is a flowchart of an illustrative process to administer and/or provide a business rule framework to one or more business units of a business organization according to one or more aspects of the present disclosure.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made.

Business organizations may utilize business rules during normal business activities to better define and/or control how the business operates and/or to ensure consistent application of one or more business policies. In many cases, business rules may be used to identify core concepts and/or to provide structure to business operations. Business rules may apply to people, processes, corporate behavior and/or computer implemented policies so that business activities may comply with a core set of business goals. For example, insurance providers may implement business rules to define parameters when processing claims, underwriting and/or providing quotations for insurance policies, and/or providing annuities. A financial institution may use business rules for evaluating loans offers (e.g., a risk, individual eligibility, pricing, and the like), account evaluations (e.g., determining related sales opportunities, identifying improper account access, issuing an alert, and the like), credit card evaluations (e.g., defining marketing opportunities, identifying improper credit card use, defining a credit limit, and the like), and/or other business functions (e.g., offering loans, brokerage activities, and the like). Healthcare organizations may define rules to evaluate patient interaction with the healthcare organization, provider interaction with patients, and/or other activities. Other business activities may include offer configuration, order management, network monitoring, online services, billing activities, contract management, claims processing, entitlement and/or benefit calculation, commissioning activities, promotions management, and/or the like.

In many cases, business rules may be used to define relationships between a business activity and a possible outcome resulting from that activity. As such, business rules may be used to define a transformation of inputs into a process and outputs resulting from the process. Some business rules may remain static once defined, while others may be changeable as processes evolve over time. Because of this changeable nature, business rule management systems (BRMS) may be used to manage these changes to ensure the business organization remains agile, to improve employee productivity and to reduce information technology costs, both in personnel time and in supporting technologies (e.g., software, hardware, and the like). BRMS may allow a business organization to control costs associated with deployment of rules, either new rules or modified versions of existing rules, to author and/or maintain rules using non-technical language, to increase decision automation, to allow for business rules to be shared between different business functions and/or business units, and other such reasons. In doing so, BRMSs may reduce costs incurred by the business organization as a result of rules changes, improve efficiency of business processes and/or to enable sharing and/or reuse of the business rules.

Many BRMS products may be available to a business organization in the marketplace. Once selected, the business organization may incur costs when purchasing and/or installing hardware and/or software infrastructure to support the BRMS. While a BRMS may be used to ensure that business rules are not hard-coded into processes so that rules are hidden or isolated within specific organizations, the BRMS, however, may be tied to the business rules and/or business processes in such a manner that changes to the BRMS itself may be difficult to implement, cost prohibitive, or both.

For example, a hardware and/or operating system requirements may differ between the different vendor products or, in some cases, between versions of a particular BRMS product. In some cases, different BRMS products may support a different combination of programming languages, so that a desired programming language may not be supported by every BRMS. Further, some vendor BRMS products may be integrated into a suite of related products, further increasing costs that may be incurred over time. Many BRMS products may also be implemented in a vendor specific manner. For example, different BRMS products may format the business rules and/or business rule designs differently so that rules implemented using a first BRMS product may not be easily translatable into a different second BRMS product. Additionally, rules repositories may be formatted to use a vendor-specific format, so that existing rules repositories may not easily be transferred between BRMS products. Further, a BRMS may require a specified hardware infrastructure to be installed. These differences may adversely impact business organizations with geographically or functionally distinct business units. For example, different BRMS products may be selected by different business units, so that business rules and/or policies may not be easily shared within the business organization.

As such, a need has been recognized for a vendor agnostic business rules framework to allow a business organization to implement and/or modify a BRMS while minimizing costs associated with the implementation. Further, the business rules framework may allow for easier sharing of business rules between business units, including improved version management capabilities, even when different BRMS are used by different business units. For example, an illustrative business rules framework may include a business system interface allowing for a common look and feel to the business rule framework to users across the business organization. These users may include rule designers, software developers, business analysts, process owners, business leaders, and/or other users associated with the business organization. Further, the business system interface may facilitate deployment of business rules to one or more rule execution servers when applying the rules to different business policies. The business rules framework may also include a BMRS interface for facilitating communication between the business rules framework and one or more BMRSs. For example, the business rules interface may allow for rule designers and/or other business users to enter and/or modify rules stored in one or more different BMRSs, while using an interface common across a plurality of business units of the business regardless of the platform being used when implementing the business rules and/or business policies utilizing the rules. The business rules framework also may allow an information technology (IT) group of the business organization update and/or modify systems associated with the business rules management system with minimal impact to users and/or business activities. Further, the business rules framework may allow for updates and/or other modifications to be performed on an installed BMRS, including changing BMRS products, without requiring users to redesign business rules and/or business policies associated with the business rules. For example, the business rules framework can allow business decision makers to evaluate an operation of different business rules management systems to allow the decision makers to select a BRMS that best suits the needs of the organization (e.g., ease of use, flexibility, cost, business infrastructure requirements, and the like). Further, when a BRMS is to be updated or replaced, the business rules framework allows for changing a vendor of the underlying BRMS without impacting the business units' operation.

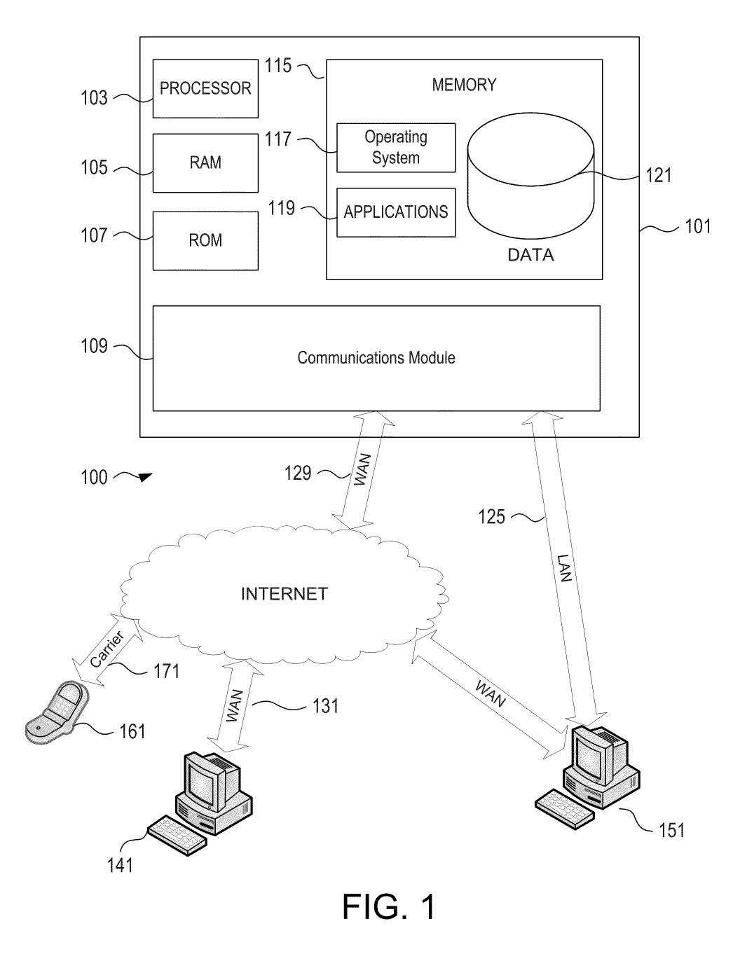

FIG. 1 illustrates a block diagram of a generic computing device 101 (e.g., a computer server) that may be used according to an illustrative embodiment of the disclosure. The computer server 101 may have a processor 103 for controlling overall operation of the server and its associated components, including RAM 105, ROM 107, input/output (I/O) module 109, and a memory 115.

The I/O module 109 may include a microphone, keypad, touch screen, and/or stylus through which a user of the computing device 101 may provide input, and may also include one or more of a speaker for providing audio output and a video display device (e.g., a user interface) for providing textual, audiovisual and/or graphical output. Software may be stored within the memory 115 and/or other storage to provide instructions to the processor 103 for enabling the server 101 to perform various functions. For example, the memory 115 may store software used by the server 101, such as an operating system 117, one or more application programs 119, and an associated database 121. Alternatively, some or all of the computer executable instructions utilized by the computing device 101 may be embodied in hardware or firmware (not shown). As described in detail below, the database 121 may provide centralized storage of account information and account holder information for the entire business, allowing interoperability between different elements of the business residing at different physical locations.

The server 101 may operate in a networked environment supporting connections to one or more remote computers, such as the terminals 141 and 151. The terminals 141 and 151 may be personal computers or servers that include many or all of the elements described above relative to the server 101. The network connections depicted in FIG. 1 may include a local area network (LAN) 125 and a wide area network (WAN) 129, but may also include other networks. When used in a LAN networking environment, the computer 101 is connected to the LAN 125 through a network interface or adapter 123. When used in a WAN networking environment, the server 101 may include a modem 127 or other means for establishing wired and/or wireless communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the server 101 according to an illustrative embodiment of the disclosure may include computer executable instructions for invoking user functionality related to communication, such as email, short message service (SMS), and voice input and speech recognition applications.

The computing device 101 and/or the terminals 141 or 151 may also be mobile terminals (e.g., a cell phone, a tablet computer, a laptop computer, a smart phone, and the like) that may include various other components, such as a battery, speaker, and/or antennas (not shown).

The disclosure is operational with numerous other general purpose or special purpose computing system environments or configurations. Examples of computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules may include routines, programs, objects, components, data structures, and the like for performing particular tasks or implementing particular abstract data types. The disclosure may also be practiced in distributed computing environments where tasks are performed by remote processing devices that are linked through a communications network. In a distributed computing environment, program modules may be located in both local and remote computer storage media including memory storage devices.

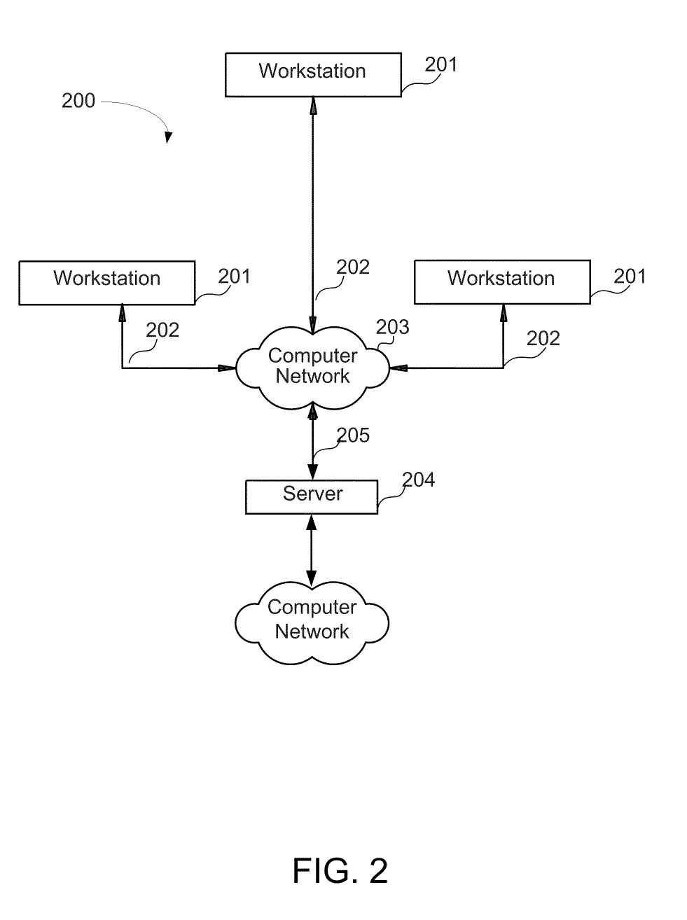

Referring to FIG. 2, an illustrative system 200 for implementing methods according to the present invention is shown. The system 200 may be a risk management system in accordance with aspects of this invention. As illustrated, system 200 may include one or more workstations 201. Workstations 201 may be local or remote, and are connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, and hard-wired links. Connectivity may also be supported to a CCTV or image/iris capturing device.

The steps that follow in the figures may be implemented by one or more of the components in FIGS. 1 and 2 and/or other components, including other computing devices.

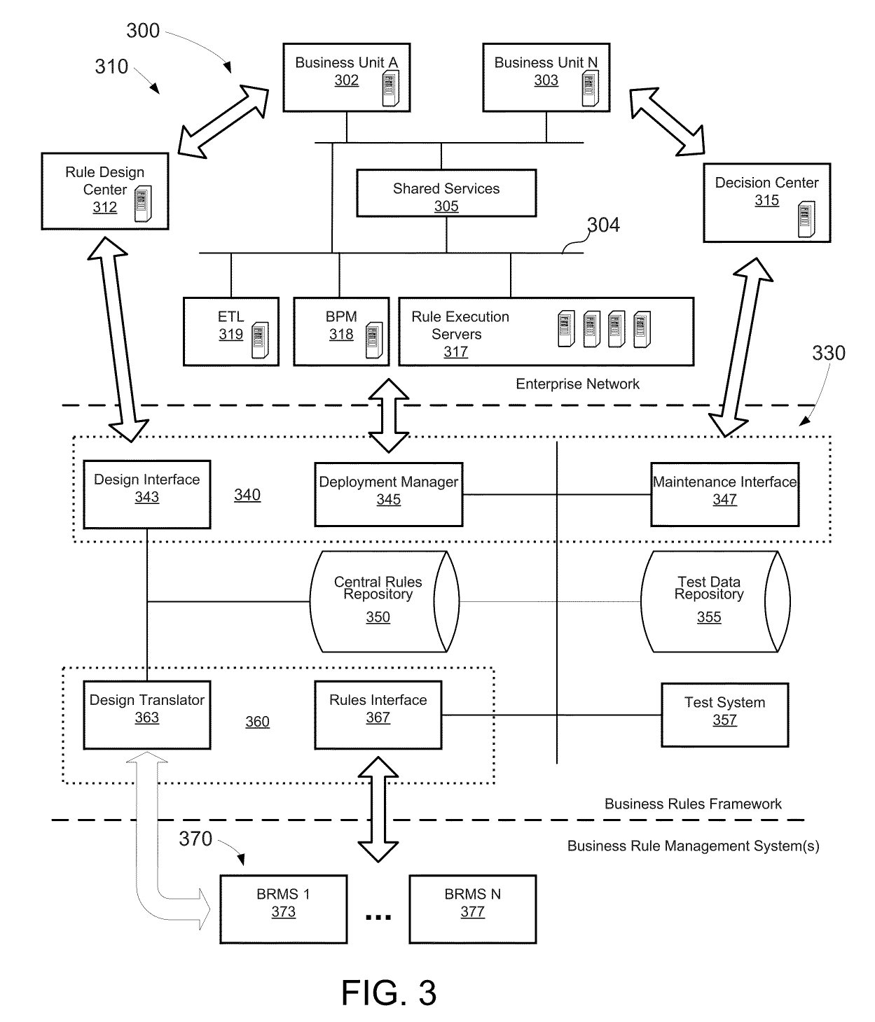

FIG. 3 shows an illustrative block diagram of a system 300 to provide a business rule framework 310 according to one or more aspects of the present disclosure. In some embodiments, the system 300 may include at least one computing device, such as the workstation 101, configured to implement the business rule framework 310. The business rule framework 310 may allow a business organization to manage the usage of one or more business rules across a plurality of business units 302, 303 and/or geographical locations in a cost effective and/or in an efficient manner. For example, the business rule framework 310 may allow the different business units 302, 303 of the business organizations to design, test, apply and/or monitor use of business rules in the business processes and/or activities in a vendor agnostic manner. To manage the business rules, the business organization may purchase, or design, a business rule management system (BRMS) 373, 374 to manage and deploy business rules across the organization.

In some cases, the business organization may be associated with one or more different business units 302, 303. These business units 302, 303 may be communicatively coupled to each other, and other device, via a network 304. The network 304 may be a wired and/or wireless communication link that may include any combination of the Internet, a WAN, a LAN, a telecommunications network, a private network, and/or the like. In some cases, the business units 302, 303 may include one or more computing systems to provide a business function. In an illustrative example, the business organization may be a financial institution with business units providing the business functions using one or more computer systems configured to provide specified business functions. For example, the business units 302, 303 may include one or more computing systems to provide one or more business functions such as a reporting computing system, a banking computer system, a brokerage computer system, a credit card services computer system, a loan management services computer system, a customer relationship management computer system, a customer service computer system, and a retirement fund services computer system. In some cases, the business units may include one or more computing systems 305 that may be configured to provide shared services, such as a login service, an account management service, and/or the like. The business units 302, 303 may implement one or more rules in the computing systems to make decisions based on specified conditions and/or in a specified context. For example, rules may be used to determine whether a customer is eligible for a specified service (e.g., if a total amount of assets is greater than a specified amount), to assess a risk (e.g., if a user is accessing an account from an unknown computing device), and/or the like.

In some cases, rules may be embedded in specified processes and/or hard-coded when performing the above-mentioned business functions. However, in doing so, changes may be difficult to manage over time. Further, different versions of the same rule may be processed in different locations and/or services, which may cause inconsistent applications of business policies. As such, in many cases, one or more rule execution servers 317 may be used to process rules from a centralized location, where the same rules can be shared between processes and/or business units. Further, by doing so, business users may better design, monitor and/or share rules and thus reduce costs associated with rules processing. In many cases, BRMSs may be used to define business rules, test the business rules before deployment, share the business rules between business groups, monitor the business rules when in use, and modify the business rules when needed. In many cases, a business process management system 318 may be used to allow a business organization to define process models, gather information about how the business processes perform and determine improvements to the processes. In many cases, business rules may be integrated into the business process models by the business process management system 318. For example, business process models may be used to meet a specified business objective, (e.g., to increase a process throughput, to reduce costs, to improve efficiency and the like). Additionally, a business organization may implement an Extraction Transformation Load (ETL) computing system 319 to facilitate data movement and/or transformation processes. The ETL process may be used to load data into data warehouses, to facilitate data integration, data migration and/or other data management initiatives. The ETL processes may include reusable components and may support parallel processing of large data volumes. When moving data, one or more business rules may be applied as part of the ETL process. As such, the ETL system may also be configured to utilize an instance of a business rule through the business rule framework.

The business rule framework 330 may be used to provide a vendor agnostic interface to allow one or more business users to design, deploy, test and/or monitor an operation of one or more business rules using a common user interface. The business rule framework 330 may allow a user (e.g., a user associated with the business units 302, 303, a rule designer, an IT professional, and the like) access to at least one BRMS 373, 377 using a common interface, regardless of a vendor or version of BRMS being used by a business organization. The business rule framework 330 may include a business rule governance interface 340 allowing the business user with the common user interface to the BRMS 373, 377, regardless of the version or vendor of the BRMS product being used. The business rule framework may also include a BRMS interface 360 configured to communicate with different BRMS products.

In some cases, the business rule governance interface 340 may include one or more interface components to allow a user access to a specified functionality of the BRMS. For example, the business rule governance interface 340 may include one or more of a design interface 343, a deployment manager 345 and/or a maintenance manager interface 347. Each of the design interface 343, a deployment manager 345 the a maintenance manager interface 347 may be configured to provide a common look and feel to the business user regardless of which BRMS product is underlying the business rule framework 330. For example, a first vendor may supply a BRMS product having a specified look and feel to users when designing rules, testing and/or monitoring the operation of rules and/or for facilitating rule deployment. A second vendor may provide a different second BRMS product having a look and feel specific to that second vendor. In such cases, the each business unit, depending on which BRMS product may have been selected for use, may specify hardware and/or software infrastructure to support that product. However, without the business rule framework 330, each business user may be required to redesign and/or reconfigure their IT infrastructure to support different BRMS products. For example, each business unit 302, 303 may have previously, and separately, selected different BRMS products for use in their respective processes. However, at a later date, the business organization may mandate use of a specific BRMS product. As such, any business unit not already using that specific BRMS product, would need to reconfigure user interfaces, install and/or upgrade operating systems, install new or upgrade existing hardware devices (e.g., servers, user interface devices, and the like). However, by using the business rule framework 330, the business organization may avoid and/or minimize these costs by allowing the individual business units to design their processes and/or install hardware based on a common specification as specified for the business rule framework 330. Any changes necessary to support a new or updated BRMS product may be accomplished behind the scenes, such as by the IT department in a centralized location. Further, by providing the business rule framework 330, a business unit 302, 303 may be allowed to use a first business rule associated with the first BRMS 373 and use a second business rule associated with the second BRMS 377 without knowing, or needing to know, any specifics as to how to access information in either BRMS 373, 377. Rather, any desired information may be gathered via the rule governance interface 350 of the business rule framework 330.

For example, a rule designer may use a rule designer computing system 312 may access the business rule framework 330 via a communication link, such as the Internet, a WAN, a LAN or the like. The design interface 343 may present one or more user interface screens to the rule designer to facilitate rule creation. In many cases, the user interface screens may allow the rule designer to define a conditional expression defining the business rule. In some cases a user interface screen may allow the user to define the rule in a specified manner. For example, a first user interface screen may be presented to the rule designer via a user interface device having a display (e.g., a monitor, a touch screen, and the like). In some cases, the user interface screen may allow the user to enter the business rule in a tabular format, in a tree structure, in a textual format (e.g., pseudo code), a flow chart, and/or the like. In some cases, the rule entry user interface screens may be similar to those of a specified BRMS product. However, in some cases, a rule entry method (e.g., a flow chart) may not normally be available to the rule designer when using BRMS 1. However, by using the business rule framework 330, the user may enter the business rule using a flow chart method, and then communicate the rule design to one or more BRMS 373, 377. In cases when the rule design method is not supported, then the rule translator 363 may be configured to translate the entered business rule into a format supported by the BRMS 373, 377 underlying the business rule framework. For example, the design translator may be configurable to translate rule designs into a format specified by a user, or may be configured to translate almost all rule designs into a pre-defined format (e.g., pseudo code) that may be supportable by at least most BRMS products. In some cases, the design interface 343 may further store the rule design in a central rules repository associated with the business rule framework 330.

In some cases, the business rule framework 330 may include one or more data repositories, such as the central rules repository 350 and the test data repository 355. These data repositories may be configured to store information associated with the business rules managed using the business rules framework 330. The data repositories 350, 355 may include a relational and/or hierarchical database. The data repositories 350, 355 may comprise an open database environment that runs on a wide variety of computing platforms, including mainframes and large distributed platforms to smaller scale personal computers. In some cases, by using Structured Query Language (SQL), users may create and edit tables in the data repositories 350, 355 to assess and manipulate data. An SQL query may cause the data repositories 350, 355 to use existing workfiles, and if necessary create new workfiles to cater to the result set returned by the query, where a workfile may be a temporary storage area that that is generally created to store intermediate relations from SQL queries. In some cases, the central repository 350 may independently store rule designs entered via the design interface 343.

In some cases, the rule designs may be stored in the appropriate BRMS 373,377. In such cases, a link, or other relational measure, may be used to identify a desired business rule within the BRMS 373, 377. For example a rule designer may enter a first rule via a user interface screen through the design interface 343. In some cases, the design interface 343 may access a configuration file to determine that the rule design is to be stored in the central rules repository 350, the BRMS or both. By storing information in the central rules repository, business users may be able to find, reuse and/or redesign business rules stored in different BRMSs 373, 377. In some cases, a record associated with a business rule may include one or more of a business rule, a link to a storage location of an instance of the business rule in one or both of the BRMS 373, 377, version information associated with the business rule, and/or a list of business units using the business rule, business processes to which the rule is assigned., versions of the business rules currently in use and/or the like.

One or more business users may access the maintenance interface 347 and/or the deployment manager 345 via a user interface screen processed by a computing device at a design center 305. For example, the deployment manager 345 may allow a business user to search for a rule for use by the business unit 302, 303, and/or for a version of a specified business rule. In many cases, the deployment manager 345 may search the central rules repository 350 exclusively. In other cases, one or more different searches may be possible. For example, the deployment manager 345 may be configurable to allow a user to perform a search of the different BRMS products underlying the business rule framework 330. Once selected, the deployment manager may allow the business user to select which version of the business rule to deploy and for how long (e.g. about 1 month, until changed, and the like.) The deployment manager 345 may then deploy an instance of the selected business rule to a specified computing device, such as the rule execution servers 317, the BPM 318, the ETL system 319, and the like. In some cases, the rules translator 367 may be used to translate a rule retrieved from the BRMS 373, 377 into a format as defined by the business rule framework 330. In some cases, the business rules may be specified to run on a particular platform and/or by using a specified programming language (e.g., Java, C, C++, and/or the like.). If not supported by a particular BRMS, the rule may be translated into the specified format, either for use by the rule execution servers 317 or for storage in the BRMS 373, 377. In some cases, such as during an upgrade process, the business rule framework 330 may be used as part of a data migration process between the old BRMS and to the new BRMS. For example, data stored in the BRMS 373 may be moved and/or translated by the rules translator 367 for import into the second BRMS 377. In some cases, similar methodology may be used to transfer information from the central rules repository 350 to one or more of the BRMS 373, 377.

In some cases, the maintenance interface 347 may allow a user to test, monitor, or otherwise maintain the business rules employed by the business organization. In some cases, the maintenance interface 347 may allow the user to access authoring, managing, validating, testing, simulating, and/or administration functionality of the BRMS 373, 377. In other cases, the business rules framework may allow for separate testing protocols to be implemented within the business rules framework, and store such information in the test data repository 355. In some cases, the business rules framework may include a test system 370 that may allow for testing of rules using consistent test information. For example, one or more test data sets may be maintained within the test data repository 355. The test system 370 may apply the test data sets to newly created rules to ensure the rule is operating as intended. In other cases, the test system 370 may be used to test for consistent operation of new rule versions as compared to previous versions.

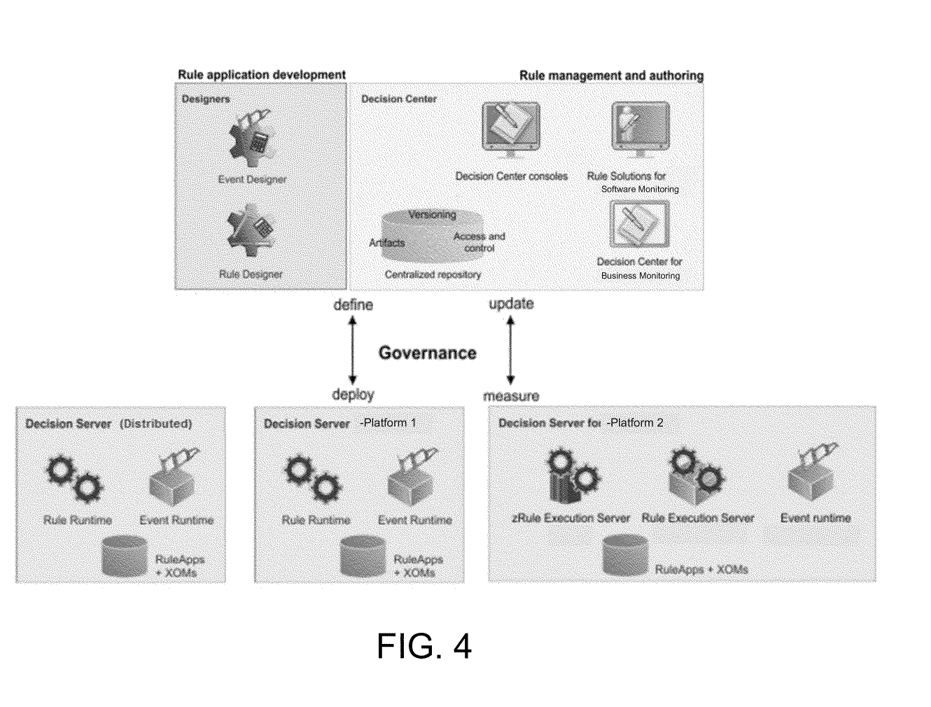

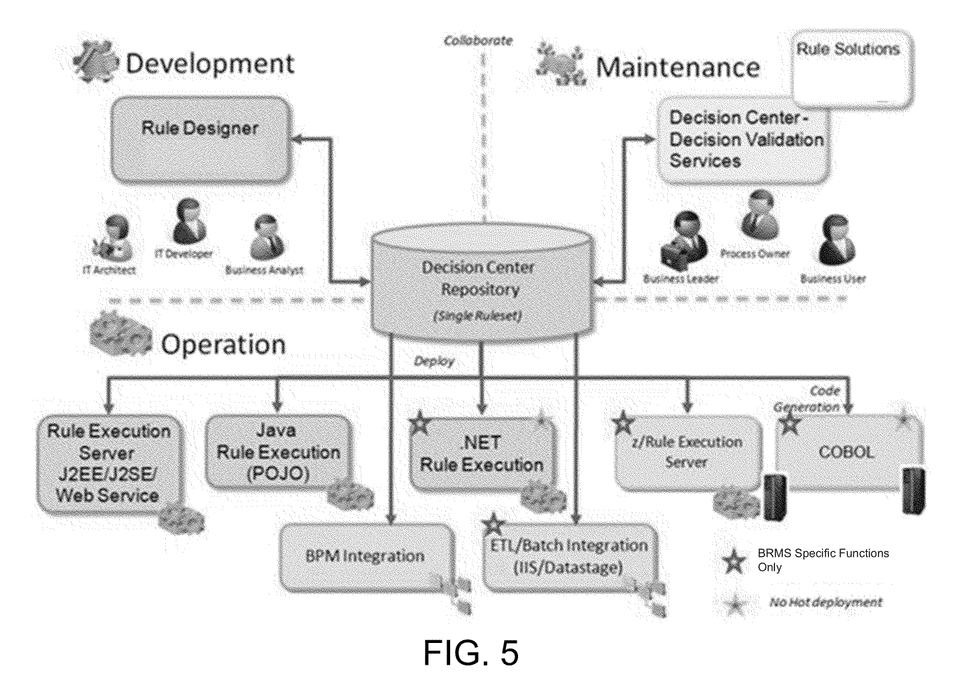

FIGS. 4 and 5 show illustrative block diagrams of systems in which a business rule framework may be used according to one or more aspects of the present disclosure. FIG. 4 shows an illustrative system in which the business rule framework 330 may be applied. The system may include a rule application development computing system that may allow designers access to the business rule system. For example, the designers may access one or more user interface screens provided by the design interface 343 to specify an operation of a business rule and/or to define an event, upon which a business rule may be triggered. For example, a rule designer may specify that a rule may be triggered upon an occurrence of a specific event. For example, a rule designer may define a triggering event to include an unexpected user login attempt from an unrecognized computer. Based on the triggering event, the rule designer may then define the rule to apply in one or more fact patters. In the above mentioned example, upon identification of the event, the user may specify that the user may not be given direct access to the requested information, but rather presented different security measures (e.g., prompt for a secondary security answer). Additionally, the maintenance interface 347 may allow a user to access one or more user interface screens to define different attributes of a business rule and/or where the rule is to be deployed. For example, the decision center may include one or more user interfaces to define versioning information of the rule, access and/or control information, artifact information and/or the like. In some cases, the user may be capable of designing one or more consoles. Further, the decision center includes one or more selections for applying the rules to one or more productivity applications (e.g. a word processor, a spreadsheet, a presentation, etc.). The business rule framework 340 may allow a user to control the evolution and application of a business rule over time by defining one or more rules governance parameters associated with rules definition, rules deployment, a rules update and/or a sales and/or marketing tool integration. In some cases, the decision servers, such as the rule execution servers 317 may process the rule logic based on an event under a specified hardware and/or operating system requirement.

FIG. 5 shows an overview of the business rule framework system 500. As can be seen the business rule framework 500 may be sued during development, maintenance and operation of the different rules. In some cases, the rule designers may include an IT architect, an IT servicer, and/or a business analyst. Similarly, the design center 315 may allow different users (e.g., a business leader such as a manager, a process owner and/or other business user access to the central rules repository 350 to validate, monitor and/or select information that may be used to validate, test or monitor the specified business rule. In some cases, the users may deploy the business rule. In many cases, one or more of the rule execution servers 317 may operate based on multiple computer languages and/or frameworks.

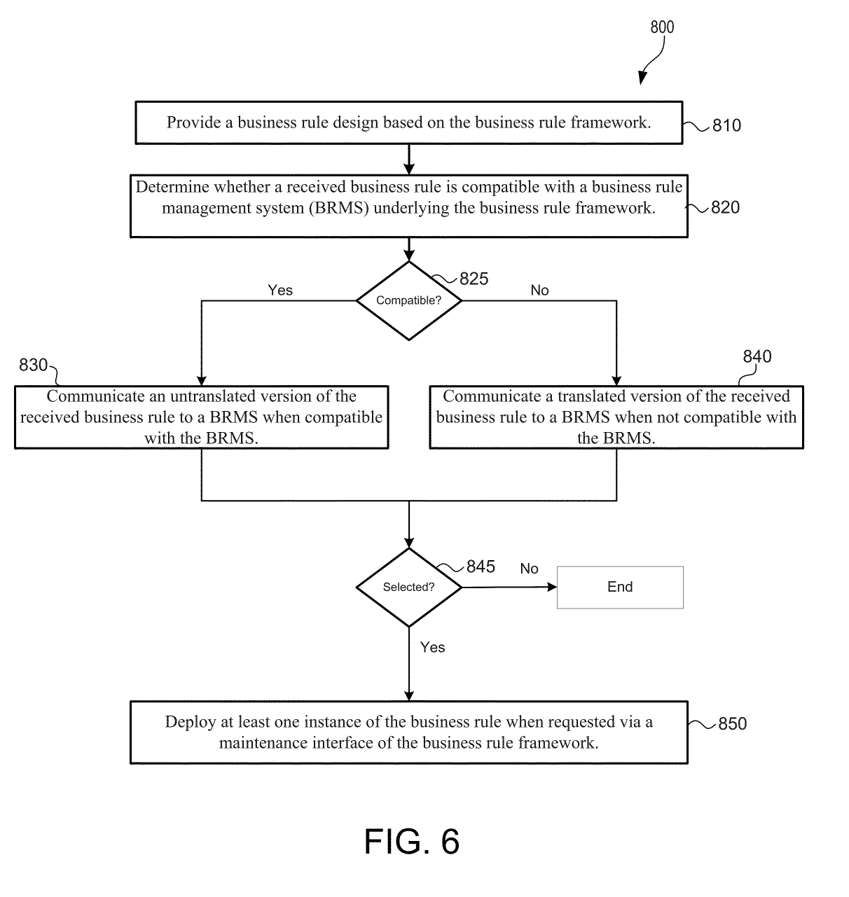

FIG. 6 is a flowchart 800 of an illustrative process to administer and/or provide a business rule framework to one or more business units of a business organization according to one or more aspects of the present disclosure. At 810, a computer device, such as the design interface 343 of the business rule framework 330 may receive at least a first rule design interface screen having a vendor agnostic business rule design interface for entry of a plurality of business rules. At 820, the design interface may determine, such as by a design translator of the business rule framework 330 may determine whether the received first business rule is compatible with a first business rule management system (BRMS) underlying the business rule framework. If so, then, at 830 communicating, by the design translator, an untranslated version of the received first business rule to the BRMS. If not, then a 840, the design translator may communicate a translated version of the received business rule to the BRMS. At 845, the deployment manager of the business rule interface 330 may determine whether a deployment input has been received for a business rule stored and/or referenced in the central rules repository 350. If so, the deployment manager may deploy, at least one instance of the business rule, such as on the one or more rule execution servers 317.

In some cases the deployment manager may determine a storage location of a desired business rule, wherein the desired business rule is stored in one of the central rules repository and the first BRMS. The deployment manager may retrieve the desired rule from one of the central rules repository when the business rule is stored in the central rules repository. In some cases, the deployment manager may retrieve the desired rule from one of the first BRMS or the second BRMS.

Although not required, one of ordinary skill in the art will appreciate that various aspects described herein may be embodied as a method, a data processing system, or as a computer-readable medium storing computer-executable instructions. Accordingly, those aspects may take the form of an entirely hardware embodiment, an entirely software embodiment or an embodiment combining software and hardware aspects. For example, a computer-readable medium storing instructions to cause a processor to perform methods in accordance with aspects of the disclosure is contemplated.

While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the elements of the aforementioned embodiments may be utilized alone or in combination or sub-combination with elements of the other embodiments. It will also be appreciated and understood that modifications may be made without departing from the true spirit and scope of the present disclosure. The description is thus to be regarded as illustrative instead of restrictive on the present disclosure.

What is claimed is:

1. A system comprising:
a business rule governance interface comprising at least one computing device, wherein the at least one computing device includes:
a business rule design interface tool comprising at least one user interface screen presented to a designer via a display device, wherein the at least one user interface screen allows a user to enter business rule information corresponding to an operation of a business rule using a common design format;
a business rule maintenance interface tool comprising at least one user interface screen presented to a user associated with a business unit and allowing the user to administer at least one of a plurality of business rules for use in one or more business processes; and
a business rule deployment manager communicating instances of the plurality business rules retrieved from a first business rules management system (BRMS) to a rule execution server for use in the one or more business processes associated with the business unit, wherein the business rules are deployed using a common deployment format; and
a business rule management system interface comprising a BRMS interface tool communicatively coupled to the business rule governance interface and configured to translate the business rule information received in the common design format into one or more different design formats, at least one of which being compatible with the first BRMS.

2. The system of claim 1, wherein the common design format comprises a vendor agnostic design interface capable of supporting a plurality of business rule management systems offered by different vendors.

3. The system of claim 1, further comprising:
the first BRMS comprising a first set of business rules, wherein the business rule management system interface tool is communicatively coupled to the first BRMS.

4. The system of claim 3, further comprising:
a second BRMS comprising a second set of business rules, wherein the BRMS interface tool is communicatively coupled to the second BRMS.

5. The system of claim 4, wherein the first BRMS is a business rule management product offered by a first vendor and the second BRMS is a business rule management product offered by a second vendor.

6. The system of claim 1, wherein the business rule management system interface tool comprises:
a design translator that translates a design entered in the common format received via the design interface into at least one of a first design format associated with the first BRMS and a second design format associated with a second BRMS.

7. The system of claim 1 further comprising:
a central rules repository communicatively coupled with the business rule governance interface and the BRMS interface, wherein the central rules repository stores a plurality of business rules for use by a plurality of business units of a business organization.

8. The system of claim 7, wherein a business rule stored in the central rules repository comprises a business rule having a common business rule format and a reference to a same business rule.

9. The system of claim 1, wherein the business rule governance interface comprises a deployment manager communicatively coupled to a plurality of rule execution servers, wherein the deployment manager provides a common interface for managing the deployment of business rules across a business organization.

10. A method comprising:
receiving, by a design interface of a business rule framework, a first rule design interface screen having a vendor agnostic business rule design interface for entry of a plurality of business rules;
determining, by a design translator of the business rule framework, whether a received first business rule is compatible with a first business rule management system (BRMS) underlying the business rule framework;
communicating, by the design translator, an untranslated version of the received first business rule to the first BRMS when compatible with the first BRMS, or a translated version of the received first business rule when not compatible with the first BRMS; and
deploying, by a deployment manager of the business rule framework, at least one instance of the first business rule when requested via a maintenance interface of the business rule framework.

11. The method of claim 10 comprising,
storing, by the design interface, the first business rule in a central data repository of the business rule framework.

12. The method of claim 11, wherein the central data repository of the business rule framework comprises a plurality of business rules and a plurality of links to business rules stored in the first BRMS.

13. The method of claim 11, further comprising:
determining, by the deployment manager a storage location of a desired business rule, wherein the desired business rule is stored in one of a central rules repository and the first BRMS; and
retrieving, by the deployment manager, the rule from the central rules repository when the business rule is stored in the central rules repository; or
retrieving, by the deployment manager via the rules interface, the desired rule from the first BRMS when the desired business rule is determined to be stored in the First BRMS.

14. The method of claim 13, further comprising:
retrieving, from the central rules repository by the rules interface, a link to the desired business rule in the first BRMS.

15. The method of claim 11, further comprising a second BRMS comprising a second set of business rules, wherein the BRMS interface tool is communicatively coupled to the second BRMS.

16. The method of claim 15, wherein the first BRMS is a business rule management product offered by a first vendor and the second BRMS is a business rule management product offered by a second vendor.

17. The method of claim 15, wherein the first BRMS is located at a first geographical location and the second BRMS is located at a second geographical location.

18. The method of claim 15 further comprising:
determining, by the deployment manager a storage location of a desired business rule, wherein the storage location comprises the second BRMS; and
retrieving, by the deployment manager, the rule from the BRMS when deployment manager determines that the business rule is stored in the second BRMS.

19. An apparatus comprising:
a user interface having a display and configured to display one or more user interface screens associated with a designing a business rule, deploying a business rule in one or more business processes, or monitoring an operation of the business rule;
a business rule governance interface comprising at least one computing device, wherein the at least one computing device includes:
a business rule design interface tool comprising at least one user interface screen presented to a designer via a display device, wherein the at least one user interface screen allows a user to enter business rule information corresponding to an operation of a business rule using a common design format;
a business rule maintenance interface tool comprising at least one user interface screen presented to a user associated with a business unit and allowing the user to administer at least one of a plurality of business rules for use in one or more business processes; and
a business rule deployment manager communicating instances of the plurality business rules retrieved from a first business rules management system (BMRS) to a rule execution server for use in the one or more business processes associated with the business unit, wherein the business rules are deployed using a common deployment format; and
a business rule management system interface comprising a BRMS interface tool communicatively coupled to the business rule governance interface and configured to translate the business rule information received in the common design format into one or more different design formats, at least one of which being compatible with the first BMRS.

20. The apparatus of claim 19, wherein the user interface comprises a distributed user interface.
